(19) United States
(12) Patent Application Publication
(10) Pub. No.: US 2025/0307190 A1
(43) Pub. Date: Oct. 2, 2025

(54) ON-CHIP COLLECTIVE OPERATIONS

(71) Applicant: Advanced Micro Devices, Inc., Santa Clara, CA (US)

(72) Inventors: Alexandru Dutu, Kirkland, WA (US); Sergey Blagodurov, Bellevue, WA (US); Wei Chen, Camas, WA (US); Ioannis Papadopoulos, Waltham, MA (US)

(21) Appl. No.: 18/619,736

(22) Filed: Mar. 28, 2024

(51) Int. Cl. G06F 13/28

(52) U.S. Cl. CPC G06F 13/28; G06F 2213/28

(57) ABSTRACT

An apparatus and method for efficiently generating memory access requests of executing machine learning data models. In various implementations, a computing system includes multiple direct memory access (DMA) circuits and multiple processing circuits. A DMA circuit generates memory access requests to retrieve multiple entries of one or more data arrays from system memory. A communication fabric receives response data from the system memory and stores the multiple entries in corresponding buffers of multiple decoupled buffers. Each of the multiple buffers is accessible by each of the multiple processing circuits and the multiple DMA circuits. The multiple buffers are separate from a cache memory subsystem. A processing circuit identifies two or more entries as source operands of a collective operation. The processing circuit generates memory access requests to retrieve from the decoupled buffers, the two or more entries as source operands to use for executing the collective operation.

### BACKGROUND

### Description of the Relevant Art

Neural networks are used in a variety of applications and domains such as physics, chemistry, biology, engineering, social media, finance, and so on. Neural networks use one or more layers of nodes to classify data in order to provide an output value representing a prediction when given a set of inputs. Weight values are used to determine the amount of influence that a change in a particular input data value will have upon a particular output data value within the one or more layers of the neural network. The cost of using a trained neural network includes providing hardware resources that can process the relatively high number of computations and can support the data storage and the memory bandwidth for accessing parameters. The parameters include the input data values, the weight values, the bias values, and the activation values.

To increase efficiency, a recommendation system that utilizes a neural network skips the matrix multiplication or other combining operation between an encoded input vector and a first hidden layer of the neural network, and instead uses a lookup operation of one or more embedding tables. Each entry of an embedding table stores a vector of weights to be used in the first hidden layer. These weights were determined during the training of the neural network. The matrix multiplication or other combining operation is replaced with the lookup operation of the one or more embedding tables. The lookup operation uses the encoded vector as an index. However, as the number of features increase, the number of users increase, and the amount of available content increases (e.g., number of songs for an online music business using a recommendation system), so do the number and size of the embedding tables. For example, the number of embedding rows (or rows) in each embedding table can reach several million.

The large number of embedding tables and the large sizes of the embedding tables cause much of the content of the embedding tables to be stored in system memory, rather than in on-die caches. Additionally, memory accesses of the embedding tables typically include irregular memory access operations such that spatial data locality and temporal data locality cannot be used to generate efficient memory accesses. Further, the next generation of artificial intelligence (AI) applications will rely on tasks for graph processing and for generating new graphs. One of the uses of graph machine learning (GML) data models is to compress large, sparse, graph data structures to generate prediction and inference values. Graph neural networks (GNNs) are used to accomplish this generation. However, these tasks degrade memory bandwidth with a high number of irregular memory accesses sent to the memory subsystem.

Furthermore, processing or generating smaller graphs from large-scale graphs can exhibit memory latency bound characteristics because of a poor performance of the memory hierarchy. For example, the graph application generates many cache misses at one or more cache levels of a cache memory subsystem as the graph application traverses and generates new graphs. Combining all these factors causes the number of generated memory access requests and the number of cache misses to increase, which reduces system performance while increasing power consumption. If an organization cannot support the cost of using machine learning data models, then the organization is unable to benefit from the machine learning data models.

In view of the above, efficient methods and apparatuses for efficiently generating memory access requests of executing machine learning data models are desired.

### BRIEF DESCRIPTION OF THE DRAWINGS

FIG. 1 is a generalized diagram of a computing system that efficiently generates memory access requests for executing machine learning data models.

FIG. 2 is a generalized diagram of a fabric switch that efficiently routes memory access requests of executing machine learning data models.

FIG. 3 is a generalized block diagram of an apparatus that efficiently schedules wavefronts for execution on an integrated circuit.

FIG. 4 is a generalized block diagram of an apparatus that efficiently generates memory access requests for executing machine learning data models.

FIG. 5 is a generalized diagram of a system in package that efficiently generates memory access requests of executing machine learning data models.

FIG. 6 is a generalized diagram of a system in package that efficiently generates memory access requests of executing machine learning data models.

FIG. 7 is a generalized block diagram of a method for efficiently generating memory access requests for executing machine learning data models.

FIG. 8 is a generalized block diagram of a method for efficiently generating memory access requests of executing machine learning data models.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently generating memory access requests of executing machine learning data models are contemplated. In various implementations, a computing system includes a communication fabric (or interconnect), system memory, multiple processing circuits that maintain a cache memory subsystem, multiple direct memory access (DMA) circuits, and multiple decoupled buffers separate from the cache memory subsystem. The buffers are “decoupled” in that they are not hosted or owned by any of the multiple processing circuits. The system memory stores data corresponding to multiple entries of a data array. In some implementations, the data array is an embedding table of a machine learning model. In an implementation, the multiple processing circuits execute instructions of a graph neural network (GNN) application and the data entries store information corresponding to vertices and edges used by the GNN application. The multiple decoupled buffers are located externally from the multiple processing circuits, but within the same semiconductor chip. Additionally, access control circuitry of each of the multiple decoupled buffers foregoes, or skips, maintaining cache coherency information. Each of the multiple decoupled buffers is accessible by each of the multiple processing circuits and the multiple DMA circuits.

When executed by circuitry of one of the processing circuits, one of an operating system, a compiler or other software assigns each of the multiple decoupled buffers to a respective address space that does not overlap with any other address spaces assigned to the other multiple decoupled buffers. A direct memory access (DMA) circuit generates multiple memory access requests to retrieve data (e.g., multiple entries of one or more data arrays) from system memory. A communication fabric or other interconnect receives response data from the system memory and stores the data in corresponding buffers of the multiple decoupled buffers based on the target addresses of the memory access requests. The communication fabric selects a decoupled buffer of the multiple decoupled buffers based on the assigned address space of the selected decoupled buffer including the target address of the memory access packet. A processing circuit identifies two or more entries of the data as source operands of a collective operation. The processing circuit generates multiple memory access requests to retrieve from one or more of the decoupled buffers, the two or more entries as source operands of the collective operation.

The processing circuit receives from one or more decoupled buffers, the two or more entries as source operands of the collective operation. To process the memory access requests, the communication fabric selects one or more decoupled buffers of the multiple decoupled buffers based on the assigned address spaces of the selected one or more decoupled buffers including the target addresses of the memory access packets. The processing circuit performs the collective operation using the two or more entries as source operands. The collective operations are accelerated, since copies of the data of the source operands are stored in the on-chip decoupled buffers, and the processing circuits do not retrieve the source operands from the off-chip system memory.

Data movement is performed in the above decoupled manner with the DMA circuits retrieving the source operands prior to the processing circuits requesting the source operands. To manage this data movement, which accelerates collective operations, a programmer modifies instructions of an application (e.g., in function calls or otherwise) or adds new instructions to the application. In an implementation, the application is a GNN application that utilizes collective operations. When executed by circuitry, the modified instructions initiate a DMA operation(s) to perform the data movement between the system memory and the multiple decoupled buffers in addition to the later decoupled data movement between the multiple decoupled buffers and the multiple processing circuits. When executed by circuitry, the instructions rely on the assigned non-overlapping address spaces to select the decoupled buffers for storage of source operands and retrieval of source operands. Further details of these techniques to efficiently generate memory access requests for executing machine learning data models are provided in the following discussion.

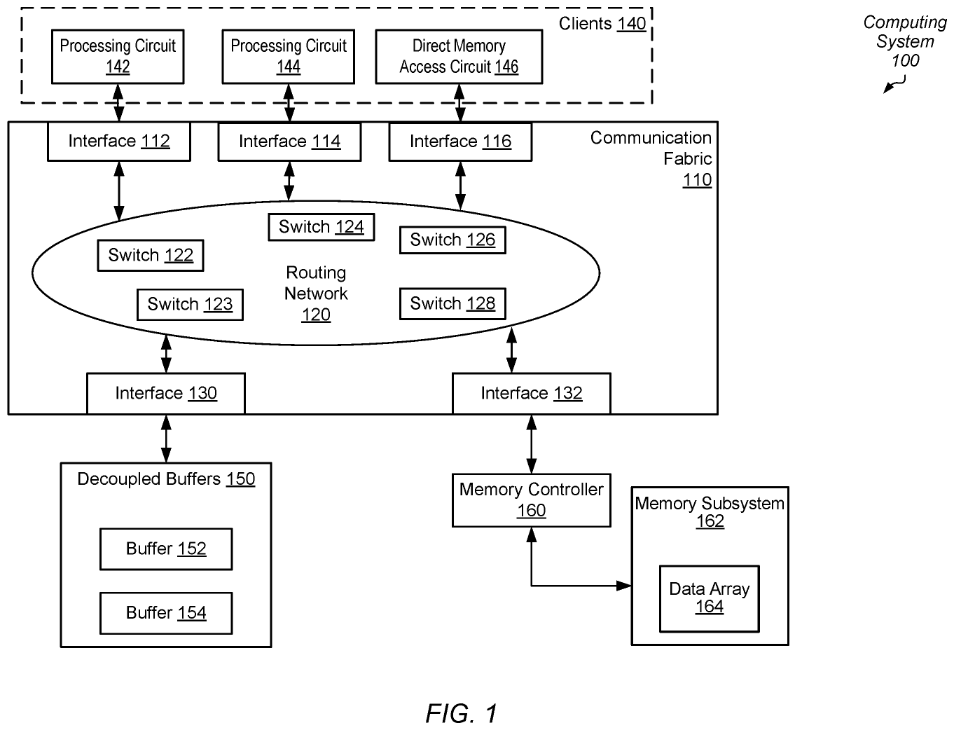

Turning now to FIG. 1, a generalized block diagram is shown of one implementation of a computing system 100 system that efficiently generates memory access requests for executing machine learning data models. As shown, computing system 100 includes communication fabric 110 between the computing clients 140, the decoupled buffers 150, and the memory controller 160. Memory controller 160 is used for interfacing with memory subsystem 162. Computing clients 140 (or clients 140) include the processing circuit 142, the processing circuit 144, and the direct memory access (DMA) circuit 146. Although three clients are shown, in other implementations, computing system 100 includes any number of clients and other types of clients, such as a network interface and so forth. In other implementations, computing system 100 includes other components and/or computing system 100 is arranged differently. Examples of the other components include a variety of types of input/output (I/O) peripheral devices, a power management circuit, clock generating circuitry, and so forth. In some implementations, the computing system 100 is a system on a chip (SoC) with each of the depicted components integrated on a single semiconductor die. In other implementations, the components are individual dies in a system-in-package (SiP) or a multi-chip module (MCM).

The processing circuits 142 and 144 are representative of any number of processing circuits which are included in the computing system 100. In some implementations, one or more of the processing circuits 142 and 144 is a parallel data processing circuit with a highly parallel data microarchitecture such as a single instruction multiple data (SIMD) microarchitecture. Parallel data processing circuits include graphics processing units (GPUs), digital signal processors (DSPs), field programmable gate arrays (FPGAs), application specific integrated circuits (ASICs), and so forth. In other implementations, the processing circuits 142 and 144 are processing cores, such as reduced instruction set computing (RISC) cores, on a system on chip (SoC).

Direct memory access (DMA) circuit 146 accesses memory, such as memory subsystem 162, independent of another processing circuit such as a processor core of an external central processing unit (CPU), an external digital signal processor (DSP), processing circuits 142 and 144, or other. Processing circuits 142 and 144 are able to process other tasks while the DMA circuit 146 performs memory access operations. The DMA circuit 146 includes circuitry and sequential elements that support one or more channels for transmitting memory access operations and receiving memory access responses. Besides system memory, the DMA circuit 146 is also capable of transferring data with another device such as processing circuits 142 and 144, a hub, a peripheral device, buffers 150, and so forth. The circuitry of the DMA circuit 146 also supports one or more communication protocols used by these components. The circuitry of the DMA circuit 146 is also capable of generating an interrupt and sending it to processing circuits 142 and 144 when the memory access operations have completed. The circuitry of the DMA circuit 146 is also capable of supporting interrupt coalescing, supporting asynchronous data transfers, supporting burst mode data transfers, and so forth.

Although a single memory controller 160 is shown, in other implementations, computing system 100 includes another number of memory controllers communicating with multiple memory devices. Memory controller 160 is representative of any type of memory controller accessible by the clients 140 and includes queues for storing memory access requests and memory access responses, and circuitry for supporting a communication protocol with the memory subsystem 162. Memory controller 160 communicates with any number and type of memory devices of the memory subsystem 162 such as Dynamic Random Access Memory (DRAM), Static Random Access Memory (SRAM), Graphics Double Data Rate (GDDR) Synchronous DRAM (SDRAM), NAND Flash memory, NOR flash memory, Ferroelectric Random Access Memory (FeRAM), or others. In one implementation, the interface 132 and the memory controller 160 transfer data with one another via a communication channel, and support one of a variety of types of the Graphics Double Data Rate (GDDR) communication protocol. In some implementations, the memory devices of the memory subsystem 162 store data in traditional DRAM or in multiple three-dimensional (3D) memory dies stacked on one another.

The clients 140 are capable of generating on-chip network data. Examples of network data include memory access requests, memory access responses, and other network messages between the clients 140. To efficiently route data, in various implementations, communication fabric 110 uses a routing network 120 that includes network switches 122-128. In some implementations, network switches 122-128 are network on chip (NoC) switches. In an implementation, routing network 120 uses multiple network switches 122-128 in a point-to-point (P2P) ring topology. In other implementations, routing network 120 uses network switches 122-128 with programmable routing tables in a mesh topology. In yet other implementations, routing network 120 uses network switches 122-128 in a combination of topologies. In some implementations, routing network 120 includes one or more buses to reduce the number of wires in computing system 100. For example, one or more of interfaces 130-132 sends read responses and write responses on a single bus within routing network 120.

In various implementations, communication fabric 110 (or fabric 110 or interconnect 110) transfers requests, responses, and messages between the clients 140, the decoupled buffers 150, and the memory controller 160. When network messages include requests for obtaining targeted data, one or more of interfaces 112, 114, 116, 130 and 132 and network switches 122-128 translate target addresses of requested data. In various implementations, one or more of fabric 110 and routing network 120 include status and control registers and other storage elements for storing requests, responses, and control parameters. In some implementations, fabric 110 includes control logic for supporting communication, data transmission, and network protocols for routing data over one or more buses. In some implementations, fabric 110 includes control logic for supporting address formats, interface signals and synchronous/asynchronous clock domain usage.

In order to maintain full throughput, in some implementations each of the network switches 122-128 processes a number of packets per clock cycle equal to a number of read ports in the switch. In various implementations, the number of read ports in a switch is equal to the number of write ports in the switch. This number of read ports is also referred to as the radix of the network switch. When one or more of the network switches 122-128 processes a number of packets less than the radix per clock cycle, the bandwidth for routing network 120 is less than maximal. Therefore, the network switches 122-128 include storage structures and control logic for maintaining a rate of processing equal to the radix number of packets per clock cycle.

In an implementation, network switches 122-128 include separate input and output storage structures. In another implementation, network switches 122-128 include centralized storage structures, rather than separate input and output storage structures. The network switches 122-128 store payload data of the packets in a separate memory structure so the relatively large amount of data is not shifted with corresponding control and status metadata stored in another queue. The network switches 122-128 include circuitry to maintain an age of packets and generate a priority level of packets. The generation of the priority level of packets includes any combination of one or more parameters such as an age, a source identifier, a destination identifier, an assigned priority level, an assigned quality of service (QOS) parameter, an assigned weight value, a data size of requested data, a data size of payload data, and so on. In various implementations, one or more of network switches 122-128 include control circuitry that selects non-contiguous queue entries for deallocation in a single clock cycle based on the generated priority. In order to maintain full throughput, the number of queue entries selected for deallocation is up to the radix of the network switch (i.e., the maximum number of packets that can be received by the switch in a single clock cycle).

Interfaces 112-116 are used for transferring data, requests, and acknowledgment responses between routing network 120 and the clients 140. Interfaces 130-132 are used for transferring data, requests, and acknowledgment responses between the routing network 120 and the memory controller 160. Similar to the network switches 122-128, interfaces 112-116 and 130-132 can include mappings between address spaces and memory channels. Similar to the network switches 122-128, the interfaces 112-116 support communication protocols with the clients 140. Similar to the network switches 122-128, interfaces 112-116 include queues for storing requests and responses, and selection circuitry for-rating between received requests before sending requests to a next stage of routing. Interfaces 112-116 also include logic for generating packets, decoding packets, and supporting communication with routing network 120. In some implementations, each of interfaces 112-116 communicates with a single client as shown. In other implementations, one or more of interfaces 112-116 communicate with multiple clients and track transferred data with a client using an identifier that identifies the client.

Memory subsystem 162 includes any number and type of memory controllers and memory devices. In one implementation, memory subsystem 162 operates at various clock frequencies which can be adjusted according to various operating conditions. However, when a memory clock frequency change is implemented, memory training is typically performed to modify various parameters, adjust the characteristics of the signals generated for the transfer of data, and so on. For example, the phase, the delay, and/or the voltage level of various memory interface signals are tested and adjusted during memory training.

The decoupled buffers 150 include buffer 152 and buffer 154. Although two buffers are shown, in other implementations, computing system 100 includes any number of buffers based on design requirements and available on-die area. In some implementations, each of the buffers 152 and 154 is one of a variety of types of on-chip random-access memory (RAM) such as Static Random Access Memory (SRAM). In various implementations, the access circuitry of the buffers 152 and 154 foregoes, or skips, maintaining cache coherency information. Therefore, buffers 152 and 154 provide data storage separate from a cache memory subsystem that includes the memory subsystem 162 and the multiple cache levels supported by the processing circuits 142 and 144. Each of buffers 152 and 154 is accessible by each of the clients 140 via the fabric 110, and the buffers 152 and 154 are selected based on assigned non-overlapping address spaces. Therefore, buffers 152 and 154 provide decentralized data storage since they are not hosted or owned by any of the clients 140.

The buffers 152 and 154 are explicitly managed for data placement. For example, the programmer includes instructions (e.g., in function calls or otherwise) of an application that performs data movement between the memory subsystem 162 and the buffers 150. In addition, the instructions in the function calls later move data from the buffers 150 to the processing circuits 142 and 144. In various implementations, the DMA circuit 146 generates memory request packets to transfer data from the memory subsystem 162 to the buffers 150. A different circuit, such as one of the processing circuits 142 and 144, generates memory request packets to retrieve data from the buffers 150. Therefore, the buffers 150 are decoupled buffers. Data movement is performed in a decoupled manner.

The address space of the computing system 100 is divided among multiple memories. When executed by circuitry of one of processing circuits 142 and 144, one of an operating system, a compiler or other software assigns each of the buffers 152 and 154 to a respective address space that does not overlap with any other assigned address space. In some designs, system memory is implemented with one of a variety of dynamic random-access memories (DRAMs). Each of the multiple memory devices used to provide the system memory services memory accesses within a particular address range. The system memory is filled with instructions and data from main memory (not shown) implemented with one of a variety of non-volatile storage devices such as a hard disk drive (HDD) or a solid-state drive (SSD). In various implementations, the address space includes a virtual address space, which is partitioned into a particular page size with virtual pages mapped to physical memory frames. These virtual-to-physical address mappings are stored in a page table in the system memory. The address space of the computing system 100 is also divided among the buffers 150. In various implementations, each of the buffers 152 and 154 stores data corresponding to a respective address range. The clients 140 access the buffers 152 and 154 using the corresponding address ranges. Similarly, memory controller 160 provides response data to buffers 152 and 154 using the corresponding address ranges.

Any local caches (not shown) of the processing circuits 142 and 144 and the memory 162, and main memory (not shown) are associated with one or more levels of a memory hierarchy. The memory hierarchy transitions from relatively fast, volatile memory, such as registers on a semiconductor die of the processing circuits 142 and 144 and caches either located on the processor die or connected to the processor die to non-volatile and relatively slow memory. In various implementations, the memory subsystem 162 stores the data array 164. In some implementations, the data array 164 is an embedding table that includes multiple embedding rows, each with an embedding row size. The embedding row size includes the data of multiple cache lines. The embedding rows of the embedding table are also referred to as the entries of the embedding table or the embedding vectors of the embedding table. Therefore, the embedding row size can also be referred to as the embedding vector size.

In various implementations, the data array 164 is used in one of a variety of types of machine learning (ML) data models. In an implementation, processing circuits 142 and 144 execute instructions of a graph neural network (GNN) application and the data entries of the data array 164 store information corresponding to vertices and edges used by the GNN application. The GNN application processes large graphs and samples these large graphs into smaller graphs or generate smaller graphs as the data model is trained. The steps for processing large graphs include generating a large number of memory accesses. However, performing the decoupled data movement using DMA circuit 146, buffers 150, and processing circuits 142 and 144 reduces memory access latency for the processing circuits 142 and 144. The collective operations performed by processing circuits 142 and 144 are accelerated by the decoupled data movement.

To manage the decoupled data movement, which accelerates collective operations, a programmer modifies instructions (e.g., in function calls or otherwise) of a graph neural network (GNN) application or other type of application. The programmer can also add new instructions to the application. When executed by one or more of processing circuits 142 and 144, the modified instructions perform the decoupled data movement between the system memory and the buffers 152 and 154 in addition to perform the later decoupled data movement between the buffers 152 and 154 and the processing circuits 142 and 144. When executed by one or more of processing circuits 142 and 144, the instructions rely on the assigned non-overlapping address spaces to select between the buffers 152 and 154 for storage of source operands and retrieval of source operands.

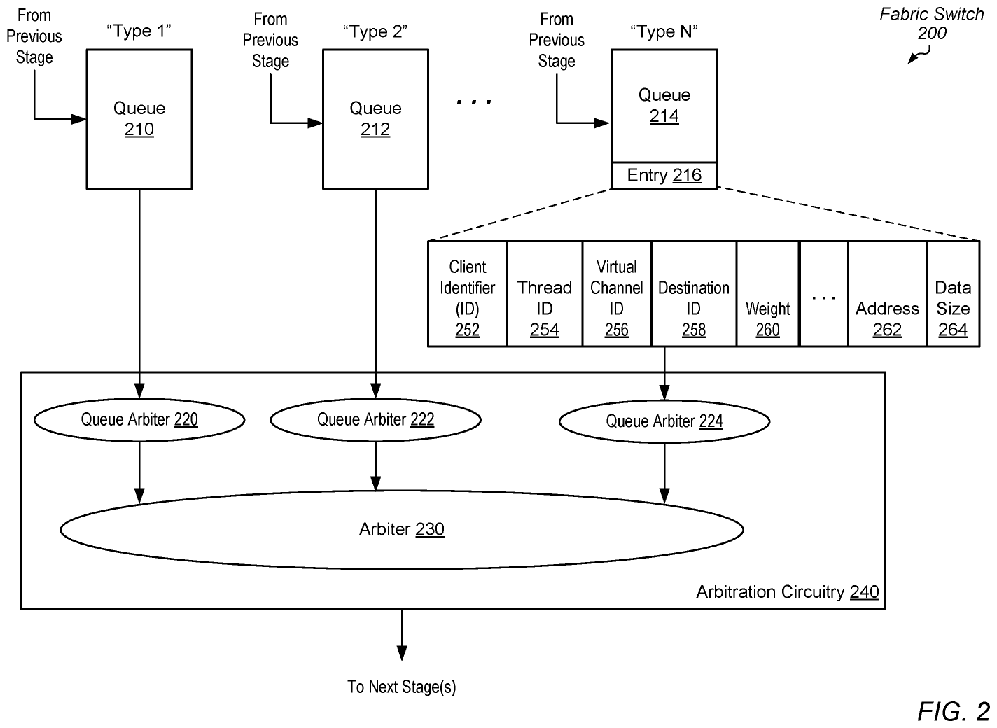

Referring to FIG. 2, a generalized block diagram is shown of an implementation of a fabric switch 200. The fabric switch 200 is a generic representation of multiple routers or switches used in a communication fabric (or interconnect) for routing packets, responses, commands, messages, payload data, and so forth. Interface circuitry, clock signals, clock generating circuitry, configuration registers, and so forth are not shown for ease of illustration. Although fabric switch 200 is shown to handle data flow in a particular direction, in some implementations, the fabric switch 200 also includes components to support data flow in the other direction as well. In other implementations, another fabric switch handles data flow in the other direction of the communication fabric. In the illustrated implementation, the fabric switch 200 includes queues 210-214, each for storing packets of a respective type. Although the data for transmission is described as packets routed in a network, such as a router network of a communication fabric, in other implementations, the data for transmission is a bit stream or a byte stream in a point-to-point (P2P) interconnection.

In various implementations, queues 210-214 store control packets to be sent on a fabric link. Corresponding data packets, such as the larger packets, are sent from another source or from other queues (not shown) within the fabric switch 200. In an implementation, the fabric switch 200 sends one or more packets on a fabric link to a next stage within the communication fabric when control circuitry of the next stage sends an indication, such as credits or other, to the fabric switch 200 specifying that there is available data storage for one or more packets.

Examples of control packet types stored in queues 210-214 include request type, response type, probe type, and a token or credit type. Other examples of packet types are also included in other implementations. As shown, queue 210 stores packets of “Type 1,” which is a control request type in an implementation. Queue 212 stores packets of “Type 2,” which are control response type in an implementation. Queue 214 stores packets of “Type N,” which are control token or credit type in an implementation. In yet other implementations, the packet types are defined by the source of the packets such as a particular processing circuit, a DMA circuit, a memory subsystem, or other.

As shown, queue 214 includes the queue entry 216 (or entry 216) that includes multiple fields 252-264. Although particular information is shown as being stored in the fields 252-264 and in a particular contiguous order, in other implementations, a different order is used, and a different number and type of information is stored. As shown, field 252 stores a client identifier (ID), field 254 stores a thread ID, and field 254 stores a virtual channel ID. Request streams from multiple different physical devices flow through virtualized channels (VCs) over the same physical link. Field 258 stores a destination ID, the field 260 stores a weight value, the field 262 stores a target address, and field 264 stores a data size of targeted data. In some implementations, field 258 stores a destination ID specifying one of multiple decoupled buffers, which was selected based on the target address stored in field 262. Other fields included in entry 216, but not shown, include a status field indicating whether an entry stores information of an allocated entry. Such an indication includes a valid bit. Another field stores an indication of the packet type. The queues 210-214 can store memory request packets from DMA circuits that act to fill low-latency, on-chip buffers with source data for collective operations. The queues 210-214 can also store memory response packets from system memory that are to be sent to the low-latency, on-chip buffers.

Queue arbiter 220 of the arbitration circuitry 240 selects one or more packets from queue 210. In some implementations, queue arbiter 220 selects packets in an out-of-order manner based on one or more attributes (arbitration attributes) that include one or more of an age, a priority level of the packet type (or data type), a priority level of the packet (or data), a quality-of-service (QOS) parameter, an assigned weight value, a source identifier, a destination identifier, an application identifier or type, such as a real-time application, an indication of data type, such as real-time data, a bandwidth requirement (or a bandwidth allocation), a latency tolerance requirement, a data size of requested data, a data size of payload data, and so forth. In a similar manner, queue arbiters 222-224 select packets from queues 212-214, and provide the selected packets to the arbiter 230. Arbiter 230 determines which of the received packets are transferred to the one or more next stages of the communication fabric. In an implementation, queue arbiters 220-224 select packets 230-234 from queues 210-214 each clock cycle.

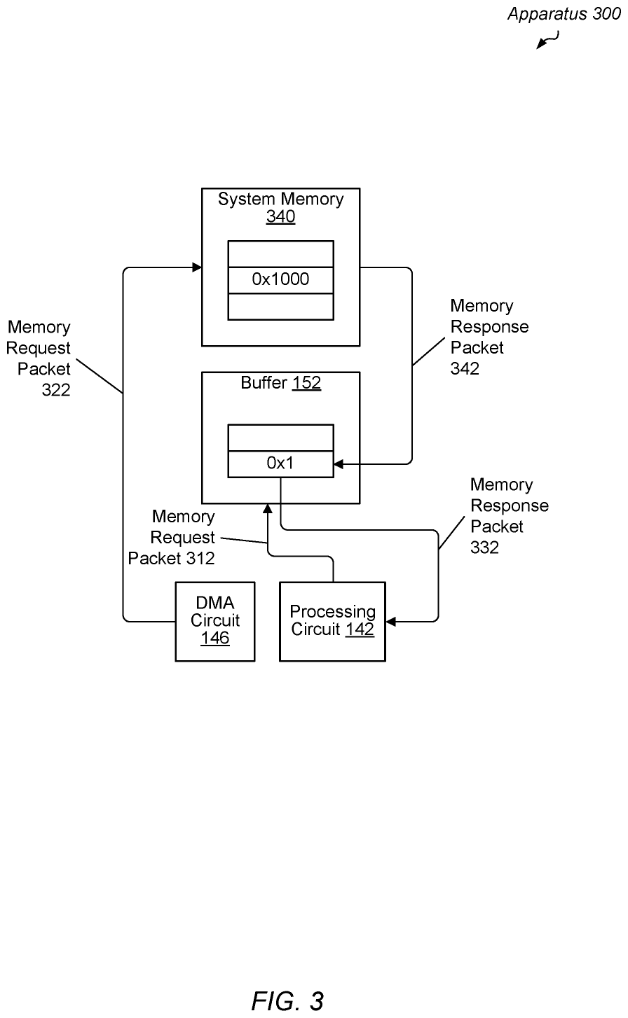

Referring to FIG. 3, a generalized diagram is shown of an implementation of an apparatus 300 that efficiently generates memory access requests for executing machine learning data models. Circuitry and components previously described are numbered identically. As shown, apparatus 300 includes the processing circuit 142, the DMA circuit 146, the buffer 152 and system memory 340. For ease of illustration, other components are not shown such as at least a communication fabric or interconnect and memory controllers. When an application, such as a GNN application, is executed by circuitry, the DMA circuit 146 generates the memory request (e.g., packet 322) that identifies the data stored in the data storage location pointed to by the address 0x1000 of system memory 340 and identifies the destination as the data storage location of buffer 152 pointed to by the address 0x1. Here, the notation “0x” indicates a hexadecimal value. System memory 340 generates the memory response packet 342 that sends the requested data as response data to buffer 152.

In various implementations, explicit instructions of an application (e.g., in a function call or otherwise) cause the data movement between system memory 340 and buffer 152. In some implementations, the function call corresponds to one of a variety of collective operations. Examples of these collective operations are a Gather operation, a Gather Random operation, a Scatter operation, a Scatter Random operation, a Reduce operation, a Scan operation, a Broadcast operation, and so forth. These collective operations can be grouped into one-sided collective operations and two-sided collective operations. Examples of the one-sided collective operations are the Sparse Gather operation, the Sparse Scatter operation, the Sparse Reduce (Reduction) operation, and the Sparse All-To-All operation. Examples of two-sided collective operations are the AllGather operation, the AllGatherRandom operation, the AllScatter operation, the AllScatterRandom operation, and the AllReduce operation. These collective operations are operations performed among multiple interconnected cores, compute circuits, and other types of processing circuits such as processing circuit 142. The use of buffer 152 accelerates the execution of these collective operations, reduces the number of generated memory accesses while the application executes, and reduces the memory access latencies.

In some implementations, the DMA circuit 146 receives a response packet (not shown), which is a control packet with no payload data, which indicates that the memory request packet 322 has been serviced. In response, the DMA circuit 146 generates an interrupt or other indication to notify the processing circuit 142 that the memory request packet 322 has been serviced. In other implementations, a barrier or other synchronization mechanism in the application being executed handles the coordination of the generation of the memory request packets by different sources. At a later time, the processing circuit 142 generates the memory request packet 312 that identifies the data stored in the data storage location pointed to by the address 0x1 of buffer 152. Buffer 152 receives the memory request packet 312 and generates the memory response packet 332 that sends the requested data as response data to processing circuit 142. Therefore, different circuits (e.g., DMA circuit 146 and processing circuit 142) fill buffer 152 with data and later access the data. Data movement is performed in a decoupled manner.

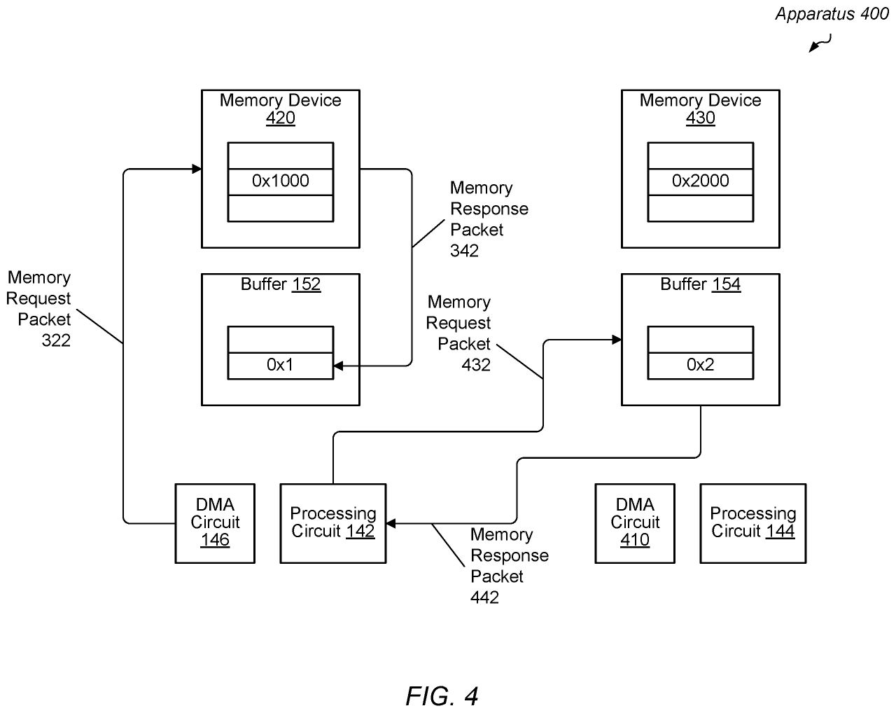

Referring to FIG. 4, a generalized diagram is shown of an implementation of an apparatus 400 that efficiently generates memory access requests for executing machine learning data models. Circuitry and components previously described are numbered identically. As shown, apparatus 400 includes the processing circuits 142 and 144, the DMA circuit 146, DMA circuit 410, the buffers 152 and 154, and system memory that includes the memory devices 420 and 430. For ease of illustration, other components are not shown such as at least a communication fabric or interconnect and memory controllers.

When an application, such as a GNN application, is executed by circuitry, the DMA circuit 146 generates the memory request packet 322 that identifies the data stored in the data storage location pointed to by the address 0x1000 of memory device 420 and identifies the destination as the data storage location of buffer 152 pointed to by the address 0x1. The memory device 420 generates the memory response packet 342 that sends the requested data as response data to buffer 152. In a similar manner, other DMA circuits also fill other buffers, such as buffer 154, with data to be used by the GNN application. Although not shown, another DMA circuit, such as DMA circuit 410, generates a memory request packet that identifies the data stored in the data storage location pointed to by the address 0x2000 of memory device 430 and identifies the destination as the data storage location of buffer 154 pointed to by the address 0x2. The memory device 430 generates a memory response packet that sends the requested data as response data to buffer 154.

In various implementations, explicit instructions of a function call of an application cause the data movement between memory devices 420-430 and buffers 152-154. In some implementations, the function call corresponds to one of a variety of collective operations. Examples of collective operations were provided earlier. The use of buffers 152-154 accelerates the execution of these collective operations, reduces the number of generated memory accesses while the application executes, and reduces the memory access latencies. At a later time, the processing circuit 142 generates the memory request packet 432 that identifies the data stored in the data storage location pointed to by the address 0x2 of buffer 154. Buffer 154 receives the memory request packet 432 and generates the memory response packet 442 that sends the requested data as response data to processing circuit 142. Therefore, different circuits (e.g., DMA circuits 146 and 410 and processing circuits 142 and 144) fill buffers 152-154 with data and later access the data. Data movement is performed in a decoupled manner.

The example shown in apparatus 400 illustrates that any of the on-chip processing circuits 142-144 can access any of the on-chip interconnected buffers 152-154. Any metadata for one-sided sparse collective operations or two-sided collective operations is managed by the instructions of the function calls of the application. For the case of one-sided sparse collective operations, any mapping between the participating buffers (e.g., buffers 152-154) and the collective operation, is managed by the instructions of the function calls of the application. When the application is a graph application that utilizes vertex and edge information, the function call performs the mapping of neighbors of vertices when the function call corresponds to a Gather operation. For the case of two-sided collective operations, when the collective operations are initiated by multiple processing circuits (e.g., processing circuits 142-144), the instructions of the function call reserve data storage space in one or more of the buffers 152-154 for storage of intermediate data generated by the two-sided collective operation. Examples of two-sided collective operations are the AllGather operation, the AllGatherRandom operation, the AllScatter operation, the AllScatterRandom operation, and the AllReduce operation.

The data movement steps shown by apparatus 300 and apparatus 400 can be used for ego-graph generation, which is a common task in graph neural network (GNN) applications. When executed by the circuitry of the DMA circuits and the processing circuits, the function calls of the GNN application can move vertices and edges from system memory to the on-chip buffers (e.g., buffers 152-154). The number of vertices and edges copied to the on-chip buffers is limited by the size of the buffers and is based on the number of available processing circuits (e.g., processing circuits 142 and 144), the size of the ego-graph, and the amount of vertex reuse in the input graph while traversing the graph. In an implementation, each of the available processing circuits (e.g., processing circuits 142 and 144) can be simultaneously generating multiple ego-graphs by traversing the graph from different start nodes and sampling neighbors up to a certain number of levels of depth. By relying on collective operations utilizing the low-latency, on-chip buffers (e.g., buffers 152-154) and taking advantage of common paths during graph traversals with different source nodes, the ego-graph generation can be accelerated. In some implementations, to ensure correct execution of the collective operations, a synchronization mechanism is used to avoid any race conditions when multiple threads are updating the same buffer location. The synchronization mechanism can include full-empty bits or synchronization primitives (e.g., locks, mutexes, barrier) used with atomic instructions to the low-latency, on-chip buffers.

To manage the data movement during the execution of GNN applications, software development kits (SDKs) and application programming interfaces (APIs) were developed for use with widely available high-level languages to provide supported function calls such as the function calls used to define the variety of collective operations. The function calls provide an abstract layer of the parallel implementation details of the processing circuits. The details are hardware specific to the particular parallel data processing circuit but hidden to the developer to allow for more flexible writing of software applications. When circuitry executes the instructions of a compiler, the circuitry compiles the generated sequence of instructions into machine executable code for execution by the SIMD circuits of compute circuits or other parallel data processing circuitry. The function calls in high level languages, such as C, C++, FORTRAN, and Java and so on, are translated to commands which are later processed by the hardware in the parallel data processing circuitry. Platforms such as OpenCL (Open Computing Language), OpenGL (Open Graphics Library), OpenGL for Embedded Systems (OpenGL ES), and Vulkan provide a variety of APIs for running programs on GPUs from AMD, Inc. Developers use OpenCL for simultaneously processing the multiple data elements of the scientific, medical, finance, encryption/decryption.

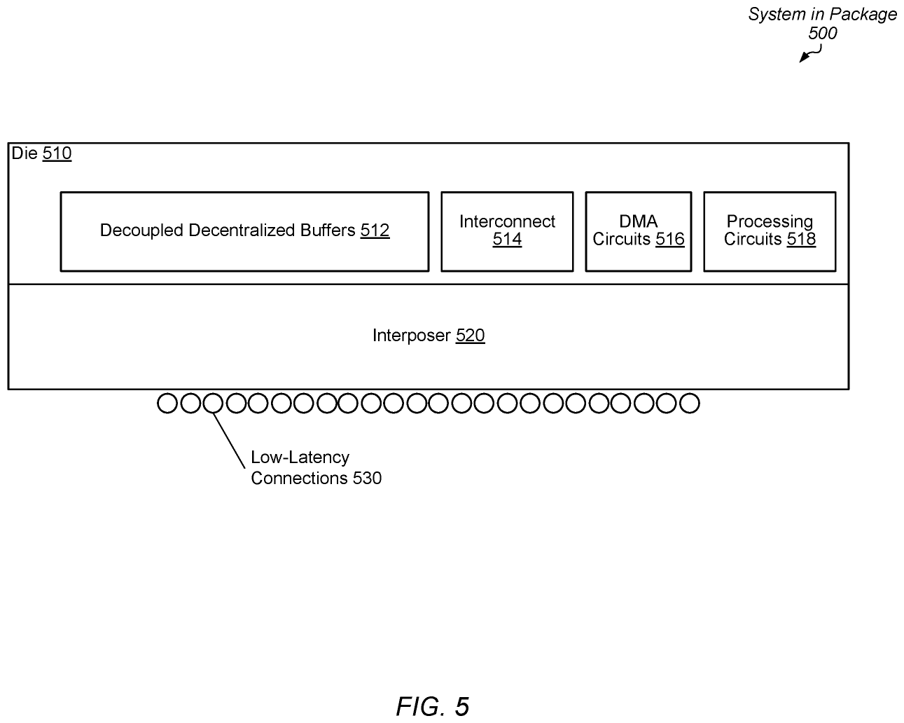

Turning now to FIG. 5, a generalized diagram is shown of a system-in-package (SiP) 500. In various implementations, three-dimensional (3D) packaging is used within a computing system to create the SiP 500. Die-stacking technology is a fabrication process that enables the physical stacking of multiple separate pieces of silicon (integrated chips) together in a same package with high-bandwidth and low-latency interconnects. Here, though, horizontal integration is shown on top of the interposer 520 with no further vertical integration. In an implementation, the semiconductor die 510 includes the decoupled, decentralized buffers 512, the interconnect 514, the DMA circuits 516, and the processing circuits 518. In various implementations, the decentralized buffers 512 have the functionality of buffers 152-154 (of FIG. 1), the interconnect 514 has the functionality of fabric 110 (of FIG. 1), the DMA circuits 516 have the functionality of DMA circuit 146 (of FIG. 1), and the processing circuits 518 have the functionality of processing circuits 142-144. As shown, the decoupled, decentralized buffers 512 are on the same die, such as die 510, as the processing circuits 518.

The SiP 500 uses the in-package horizontal, low-latency integrated interconnect (not shown), which provides reduced lengths of interconnect signals versus long off-chip interconnects. The SiP 500 also uses through silicon vias (TSVs), which tunnel through a silicon substrate and oxide layers and ends at the metal layers and vias in the die 510. The printed circuit board is located below the interposer 520 and the package external connections 530. In various implementations, the package external connections 530 are one of a variety of surface mount device (SMD) pins that allow the SiP 500 to be placed directly onto the surface of the printed circuit board or placed directly on a redistribution layer (RDL), if a RDL is used.

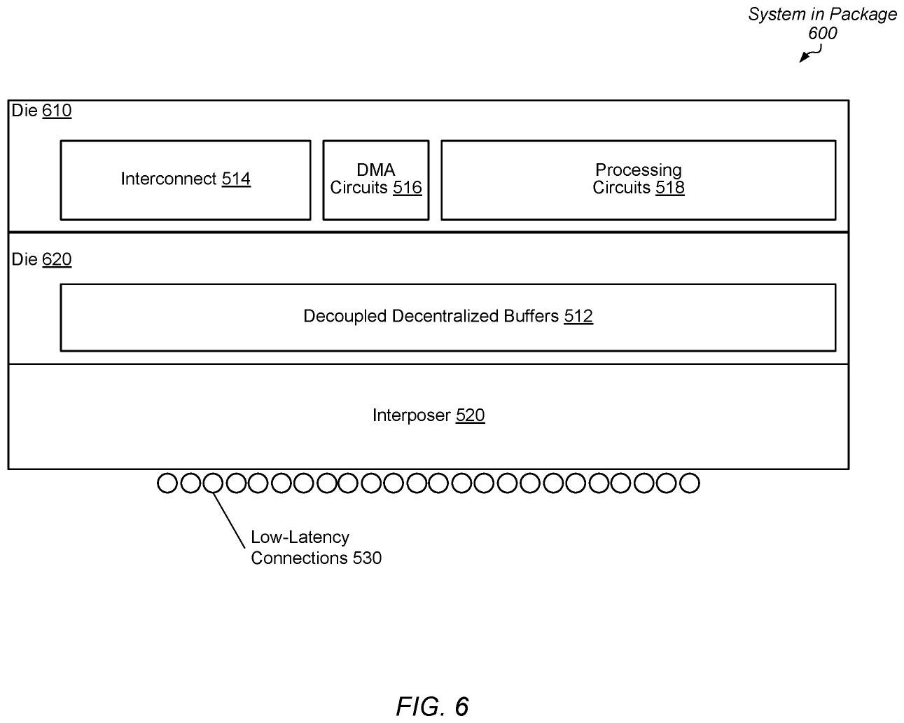

Referring to FIG. 6, a generalized diagram is shown of a system-in-package (SiP) 600. Circuits, semiconductor fabrication materials, layers and components previously described are numbered identically. In an implementation, the base semiconductor die 620 and the stack semiconductor die 610 are included in a package of System in Package (SiP) 600, which utilizes three-dimensional (3D) integrated circuits (ICs). A 3D IC includes two or more layers of active electronic components integrated both vertically and/or horizontally into a single circuit. Here, both horizontal and vertical integration is shown. As shown, the decoupled, decentralized buffers 512 are on die 620, which is stacked underneath the die 610 that includes the processing circuits 518.

It is possible and contemplated that one or more of the dies, processing circuits, and apparatuses illustrated in FIGS. 1-6 are implemented as chiplets. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet.

A second silicon wafer (or second wafer) is fabricated with multiple instantiated copies of integrated circuitry of a second chiplet, and this second wafer is diced using laser cutting techniques to separate the multiple copies of the second chiplet. The first chiplet provides functionality different from the functionality of the second chiplet. One or more copies of the first chiplet are placed in an integrated circuit, and one or more copies of the second chiplet is placed in the integrated circuit. The first chiplet and the second chiplet are interconnected to one another within a corresponding MCM. Such a process replaces a process that fabricates a third silicon wafer (or third wafer) with multiple copies of a single, monolithic semiconductor die that includes the functionality of the first chiplet and the second chiplet as integrated functional blocks within the single, monolithic semiconductor die.

Process yield of single, monolithic dies on a silicon wafer is lower than process yield of smaller chiplets on a separate silicon wafer. In addition, a semiconductor process can be adapted for the particular type of chiplet being fabricated. With single, monolithic dies, each die on the wafer is formed with the same fabrication process. However, it is possible that an interface functional block does not require process parameters of a semiconductor manufacturer's expensive process that provides the fastest devices and smallest geometric dimensions. With separate chiplets, designers can add or remove chiplets for particular integrated circuits to readily create products for a variety of performance categories. In contrast, an entirely new silicon wafer must be fabricated for a different product when single, monolithic dies are used. It is possible and contemplated that one or more of the processing circuits, the compute circuits, and apparatuses illustrated in FIGS. 1-6 are implemented as chiplets.

In some implementations, the hardware of the processing circuits and the apparatuses illustrated in FIGS. 1 and 6 is provided in a two-dimensional (2D) integrated circuit (IC) with the dies placed in a 2D package. In other implementations, the hardware is provided in a three-dimensional (3D) stacked integrated circuit (IC). A 3D integrated circuit includes a package substrate with multiple semiconductor dies (or dies) integrated vertically on top of it. Utilizing three-dimensional integrated circuits (3D ICs) further reduces latencies of input/output signals between functional blocks on separate semiconductor dies. It is noted that although the terms “left,” “right,” “horizontal,” “vertical,” “row,” “column,” “underneath,” “top,” and “bottom” are used to describe the hardware, the meaning of the terms can change as the integrated circuits are rotated or flipped.

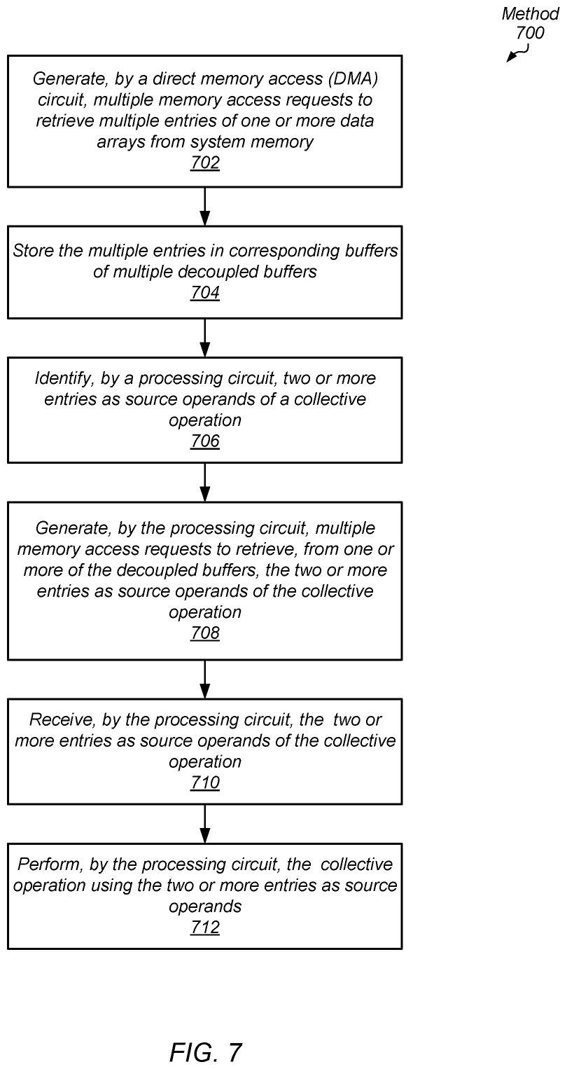

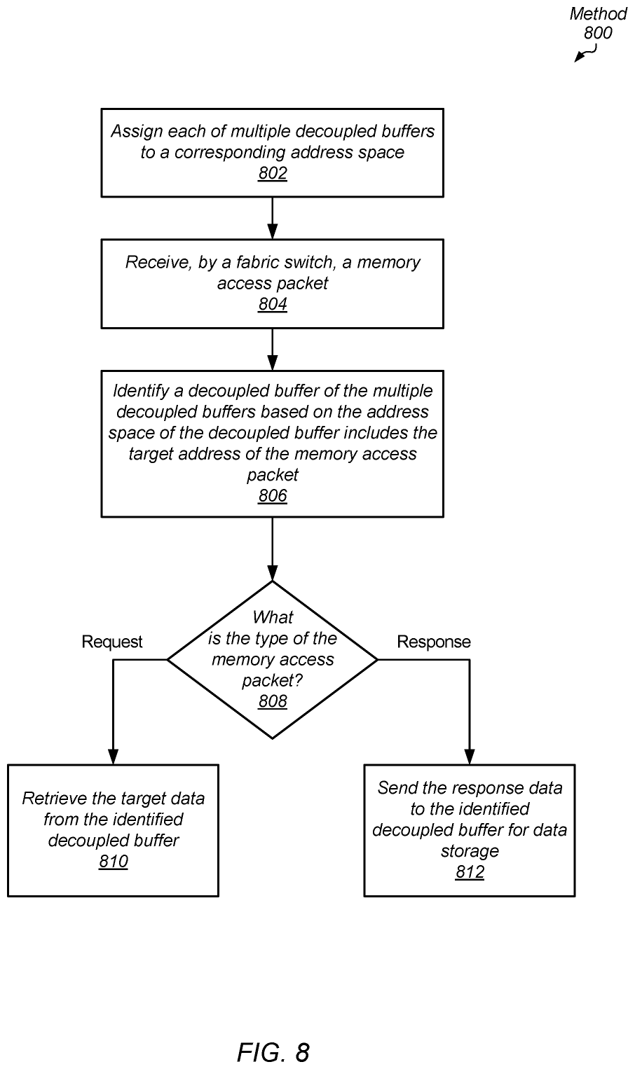

Regarding the methods 700-800 (of FIGS. 7-8), a computing system includes a communication fabric (or interconnect), system memory, multiple processing circuits that maintain a cache memory subsystem, multiple direct memory access circuits, and multiple buffers separate from the cache memory subsystem. It is possible and contemplated that the computing system includes one or more other components. The system memory stores data of multiple entries of a data array. In some implementations, the data array is an embedding table of a machine learning model. In an implementation, the multiple processing circuits execute instructions of a graph neural network (GNN) application and the data entries store information corresponding to vertices and edges used by the GNN application. In various implementations, the multiple buffers are located externally from the multiple processing circuits, but within the same semiconductor chip. Additionally, access control circuitry of each of the multiple buffers foregoes, or skips, maintaining cache coherency information. Each of the multiple buffers is accessible by each of the multiple processing circuits and the multiple direct memory access circuits.

Referring to FIG. 7, a generalized diagram is shown of a method 700 for efficiently generating memory access requests for executing machine learning data models. For purposes of discussion, the steps in this implementation (as well as FIG. 8) are shown in sequential order. However, in other implementations some steps occur in a different order than shown, some steps are performed concurrently, some steps are combined with other steps, and some steps are absent.

A direct memory access (DMA) circuit generates multiple memory access requests to retrieve data (e.g., multiple entries of one or more data arrays or otherwise) from system memory (block 702). A communication fabric or other interconnect receives response data from the system memory and stores the multiple entries in corresponding buffers of multiple decoupled buffers (block 704). A processing circuit identifies two or more entries as source operands of a collective operation (block 706). The processing circuit generates multiple memory access requests to retrieve from one or more of the decoupled buffers (e.g., the two or more entries as source operands of the collective operation) (block 708). The processing circuit receives two or more entries as source operands of the collective operation (block 710). The processing circuit performs the collective operation(s) using the two or more entries as source operands (block 712).

Turning now to FIG. 8, a generalized diagram is shown of a method 800 for efficiently generating memory access requests. In various implementations, an operating system assigns each of the multiple decoupled buffers to a corresponding address space (block 802). Each of the multiple decoupled buffers is assigned to a respective address space that does not overlap with any other address space assigned to the multiple decoupled buffers. In other implementations, such an assignment is performed by instructions generated by a compiler, different software, or otherwise. Each of the multiple decoupled buffers stores data accessible by each of the multiple processing circuits in the computing system. A fabric switch of a communication fabric (or interconnect) receives a memory access packet (block 804). The fabric switch identifies and selects a decoupled buffer of the multiple decoupled buffers based on the assigned address space of the decoupled buffer that includes the target address of the memory access packet (block 806).

If the type of the memory access packet is a memory request packet (“request” branch of the conditional block 808), then the communication fabric retrieves the target data from the identified decoupled buffer (block 810). The communication fabric retrieves the target data from the identified decoupled buffer and sends the target data to the requesting processing circuit. This type of memory access packet is similar to the memory request packet 312 (of FIG. 3). If the type of memory access packet is a memory response packet (“response” branch of the conditional block 808), then the communication fabric sends the response data to the identified decoupled buffer for data storage (block 812). In an implementation, the communication fabric retrieves the target data from system memory and sends the target data to the identified decoupled buffer. This type of memory access packet is similar to the memory response packet 342 (of FIG. 3).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage.

Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An integrated circuit comprising:
a plurality of buffers configured to store data, wherein each of the plurality of buffers is assigned to an address space of a plurality of address spaces that does not overlap with an address space assigned to other buffers of the plurality of buffers; and
a direct memory access circuit is configured to generate a first memory request to retrieve first data from system memory into a first buffer of the plurality of buffers, responsive to the first buffer being assigned to an address space that corresponds to an address space targeted by the first memory request.

2. The integrated circuit as recited in claim 1, further comprising a plurality of processing circuits, each configured to generate memory requests targeting data stored in any of the plurality of buffers.

3. The integrated circuit as recited in claim 2, wherein a first processing circuit of the plurality of processing circuits is further configured to generate a second memory request to retrieve the first data from the first buffer into the first processing circuit, responsive to the first buffer being assigned to an address space that corresponds to an address space targeted by the second memory request.

4. The integrated circuit as recited in claim 3, wherein each of the direct memory access circuit and the plurality of processing circuits is further configured to generate memory requests targeting a plurality of entries of a data array used as an embedding table of a machine learning data model.

5. The integrated circuit as recited in claim 4, wherein the first processing circuit is further configured to generate result data by performing a collective operation using copies of data of two or more entries of the plurality of entries stored in any of the plurality of buffers.

6. The integrated circuit as recited in claim 3, wherein the direct memory access circuit is further configured to generate a third memory request to retrieve second data from the system memory into a second buffer of the plurality of buffers, responsive to the second buffer being assigned to an address space that corresponds to an address space targeted by the third memory request.

7. The integrated circuit as recited in claim 6, wherein a second processing circuit of the plurality of processing circuit is further configured to generate a fourth memory request to retrieve the second data from the second buffer into the second processing circuit, responsive to the second buffer being assigned to an address space that corresponds to an address space targeted by the fourth memory request.

8. A method comprising:
storing data by circuitry of a plurality of buffers, wherein each of the plurality of buffers is assigned to an address space of a plurality of address spaces that does not overlap with an address space assigned to other buffers of the plurality of buffers; and
generating, by a direct memory access circuit, a first memory request to retrieve first data from system memory into a first buffer of the plurality of buffers, responsive to the first buffer being assigned to an address space that corresponds to an address space targeted by the first memory request.

9. The method as recited in claim 8, further comprising generating memory requests targeting data stored in any of the plurality of buffers by a plurality of processing circuits.

10. The method as recited in claim 9, further comprising generating, by a first processing circuit of the plurality of processing circuits, a second memory request to retrieve the first data from the first buffer into the first processing circuit, responsive to the first buffer being assigned to an address space that corresponds to an address space targeted by the second memory request.

11. The method as recited in claim 10, further comprising generating, by each of the direct memory access circuit and the plurality of processing circuits, memory requests targeting a plurality of entries of a data array used as an embedding table of a machine learning data model.

12. The method as recited in claim 11, further comprising generating, by the first processing circuit, result data by performing a collective operation using copies of data of two or more entries of the plurality of entries stored in any of the plurality of buffers.

13. The method as recited in claim 10, further comprising generating, by the direct memory access circuit, a third memory request to retrieve second data from the system memory into a second buffer of the plurality of buffers, responsive to the second buffer being assigned to an address space that corresponds to an address space targeted by the third memory request.

14. The method as recited in claim 13, further comprising generating, by a second processing circuit of the plurality of processing circuits, a fourth memory request to retrieve the second data from the second buffer into the second processing circuit, responsive to the second buffer being assigned to an address space that corresponds to an address space targeted by the fourth memory request.

15. A computing system comprising:
a plurality of processing circuits;
one or more direct memory access circuits; and
a plurality of buffers configured to store data, wherein each of the plurality of buffers is assigned to an address space of a plurality of address spaces that does not overlap with an address space assigned to other buffers of the plurality of buffers; and
wherein a first direct memory access circuit of the one or more direct memory access circuits generates a first memory request to retrieve first data from system memory into a first buffer of the plurality of buffers, responsive to the first buffer being assigned to an address space that corresponds to an address space targeted by the first memory request.

16. The computing system as recited in claim 15, wherein each of the plurality of processing circuits is further configured to generate memory requests targeting data stored in any of the plurality of buffers.

17. The computing system as recited in claim 16, wherein a first processing circuit of the plurality of processing circuits is further configured to generate a second memory request to retrieve the first data from the first buffer into the first processing circuit, responsive to the first buffer being assigned to an address space that corresponds to an address space targeted by the second memory request.

18. The computing system as recited in claim 17, wherein each of the plurality of direct memory access circuits and the plurality of processing circuits is further configured to generate memory requests targeting a plurality of entries of a data array used as an embedding table of a machine learning data model.

19. The computing system as recited in claim 18, wherein the first processing circuit is further configured to generate result data by performing a collective operation using copies of data of two or more entries of the plurality of entries stored in any of the plurality of buffers.

20. The computing system as recited in claim 17, wherein the first direct memory access circuit is further configured to generate a third memory request to retrieve second data from system memory into a second buffer of the plurality of buffers, responsive to the second buffer being assigned to an address space that corresponds to an address space targeted by the third memory request.
